(19) United States
(12) Patent Application Publication
(10) Pub. No.: US 2023/0259399 A1
(43) Pub. Date: Aug. 17, 2023

(54) METHOD AND ELECTRONIC DEVICE FOR HANDLING RESOURCE OPERATING PERFORMANCE CONFIGURATION IN ELECTRONIC DEVICE

(71) Applicant: Samsung Electronics Co., Ltd., Suwon-si (KR)

(72) Inventors: Abhilasha RAO, Bengaluru (IN); Syama SUDHEESH, Bengaluru (IN); Rishabh RAJ, Bengaluru (IN); Sarthak Sarthak, Bengaluru (IN); Pavan NITTUR, Bengaluru (IN); Myungsu CHA, Suwon-si (KR); Vighnesh HEGDE, Bengaluru (IN); Renju Chirakarotu NAIR, Bengaluru (IN); Vaisakh Punnekkattu Chirayil SUDHEESH BABU, Bengaluru (IN); Kwangsik CHOI, Suwon-si (KR); Hyungseok YU, Suwon-si (KR); Nidhal Kottamoola IBRAHIMKUTTY, Bengaluru (IN); Sunil MOURYA, Bengaluru (IN)

(21) Appl. No.: 18/305,933

(22) Filed: Apr. 24, 2023

Related U.S. Application Data
(63) Continuation of application No. PCT/KR2022/011361, filed on Aug. 2, 2022.

(30) Foreign Application Priority Data
Aug. 2, 2021 (IN) 202141034780
Jul. 15, 2022 (IN) 202141034780

(51) Int. Cl. G06F 9/50

(52) U.S. Cl. CPC G06F 9/5027

(57) ABSTRACT

A method for handling at least one resource operating performance configuration in an electronic device by the electronic device is provided. The method includes determining at least one event that is generated by the at least one application from a plurality of applications running in the electronic device. Further that requires acceleration of the at least one application from the plurality of applications running in the electronic device, the method includes fetching a system configuration based on the determination. Further, the method includes modifying the system configuration for each event to accelerate the execution of each event associated with the at least one application running in the electronic device. The method includes accelerate execution of the application running in the electronic device based on the modified system configuration.

### CROSS REFERENCE TO RELATED APPLICATION

This application is a continuation application, claiming priority under § 365(c), of an International application No. PCT/KR2022/011361, filed on Aug. 2, 2022, which is based on and claims the benefit of an Indian Provisional patent application number 202141034780, filed on Aug. 2, 2021, in the Indian Intellectual Property Office, and of an Indian Complete patent application number 202141034780, filed on Jul. 15, 2022, in the Indian Intellectual Property Office, the disclosure of each of which is incorporated by reference herein in its entirety.

### BACKGROUND

### 1. Field

The disclosure relates to enterprise scenarios. More particularly, the disclosure relates to methods and an electronic device for handling a resource operating performance configuration in the electronic device to improve a performance in the enterprise scenarios.

### 2. Description of the Related Art

In general, business to business (B2B) applications' use case scenario(s) are unable to fully utilize the underlying hardware processing capability (e.g., central processing unit (CPU), graphics processing unit (GPU), etc.), when a high performance scenario requires it. For achieving the high performance, huge development effort needs to be put in either by B2B application/use case developer(s) to understand the underlying system or performance knob(s) and tune them, which can be very much hardware specific.

Original equipment manufacturers (OEMs)/vendors identify and tune scenario specific boosting for performance knobs and statically map to use case scenario(s).

Both these approaches are not scalable and maintainable as they involve significant effort, and each product has specific configurations (hardware and operating system (OS) versions) to be deployed/shipped.

Further, in the existing methods and systems, no learning engine is used and a very limited scenario support is provided for acceleration of the application achieving the high performance. The existing methods do not focus on the enterprise use-cases, and in case usecase changes, application developer need change programming also to accelerate the application.

Further, in the exiting methods and systems, boosting for the application is performed based on a CPU frequency, a GPU frequency and a Bus Frequency. the boosting for the application is performed by default and not to application specific.

FIG. 1 is an example illustration in which operation of a performance booster is explained, according to the related art.

Referring to FIG. 1 (represented as 100), the boosting can be seen as increasing the bandwidth availability (i.e., CPU/GPU available time for application processes), so that more time is available quickly completing its operation.

By default, operating system processes are fairly scheduled, that means all processes of all applications are given equal/fair share of CPU time. This implies, when boosted also, all processes running on the operating system including the targeted application being considered gets accelerated. Application or OEMs need to be aware of time duration to which boosting has to be done. These timings can vary across different hardware (e.g., chipset, random access memory (RAM), etc.). Also, manual tuning required for each product/chipset.

Further, the existing method doesn't account for system context like load, thermal or per core occupancy, while applying on the usecase scenario start, duration between start and end. The existing method doesn't account for all possible factors influencing the operation. What is configured in lab continues to remain the same in market/real time assuming that a user of the application does not install more applications or any other user characteristics. In an example, if the user of the electronic device is a game player, thermal shoot-up is normal and user immediately open the targeted application, the pre-configured boost will not work up to expectations to provide optimal or best performance which was achieved earlier. Pre-configured booster configurations are considering idle system load situations only. Whatever boost is applied, the share of the boost goes to every process in the electronic device. So, it will never give targeted performance if there are more processes which share the boosted configuration.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and electronic device for handling at least one resource operating performance configuration in the electronic device to improve/enhance a performance in the enterprise scenarios.

Another aspect of the disclosure is to improve performance in enterprise scenarios, wherein business-to-business (B2B) applications are provided with minimalistic application programming interface (API) for allowing to utilize underlying hardware/software performance features to improve performance in their respective heavy use case scenario(s) without significant manual effort.

Another aspect of the disclosure is to enable B2B use case/scenario performance management, which learns on its own under varying system load condition what is the appropriate performance knobs to achieving best possible performance for an integrated scenario under different load condition.

Another aspect of the disclosure is to modify the electronic device configuration for each event in an application for accelerated execution of each event and feeding the modified system configuration for each event to an artificial intelligence (AI) model, such that for every subsequent execution of the application, each event is accelerated by setting an optimal system configuration.

Another aspect of the disclosure is to allow faster and agile learning of appropriate performance knob(s) configuration to obtain best possible performance for a usecase scenario utilizing a resource operating performance configuration allocation controller.

Additional aspects will be set forth in part in the description which follows and, in part, will be apparent from the description, or may be learned by practice of the presented embodiments.

In accordance with an aspect of the disclosure, a method for handling at least one resource operating performance configuration in the electronic device is provided. The method includes determining, by the electronic device, at least one event that is generated by the at least one application from a plurality of applications running in the electronic device that requires acceleration of the at least one application from the plurality of applications running in the electronic device. Further, the method includes fetching, by the electronic device, a system configuration based on the determination. Further, the method includes modifying, by the electronic device, the system configuration for each event to accelerate the execution of each event associated with the at least one application running in the electronic device. The method includes accelerating, by the electronic device, execution of the application running in the electronic device.

In an embodiment, the method further includes feeding, by the electronic device, the modified system configuration for each event to a data driven model. Each event is accelerated by setting the modified system configuration. The modified system configuration is fed to the data driven model for self-learning over a period of time.

In an embodiment, modifying, by the electronic device, the system configuration for each event to accelerate the execution of each event associated with the at least one application running in the electronic device includes determining, by the electronic device, a nature of a task associated with the at least one application running in the electronic device and at least one parameter associated with at least one application running in the electronic device, learning, by the electronic device, at least one system configuration for the determined nature of the task associated with the at least one application running in the electronic device and the determined parameter associated with the at least one application running in the electronic device, and modifying, by the electronic device, the system configuration for each event from the at least one event to accelerate the execution of each event associated with the at least one application running in the electronic device based on learning.

In an embodiment, the at least one parameter includes at least one of a system load, temperature, power, or thermal balancing.

In an embodiment, the method further includes detecting, by the electronic device, a trigger for each event from the at least one event to accelerate execution of the at least one event, wherein the trigger is a start of an event from the at least one event.

In an embodiment, the method includes comprises detecting, by the electronic device, at least one parameter as an input to set an optimal system configuration for accelerated execution of each event in the electronic device.

In an embodiment, the resource operating performance configuration includes at least one of a central processing unit (CPU) Operating Performance Point (OPP), a graphics processing unit (GPU) OPP, a process aware scheduler configuration, an energy aware scheduler configuration, a process thread scheduling configuration and priority scheduling configuration.

In accordance with another aspect of the disclosure, a method for handling at least one resource operating performance configuration in the electronic device is provided. The method includes determining, by the electronic device, a nature of a task associated with the at least one application from a plurality of applications running in the electronic device and a parameter associated with at least one application running in the electronic device. Further, the method includes learning, by the electronic device, at least one system configuration for the determined nature of the task associated with the at least one application running in the electronic device and the determined parameter associated with the at least one application running in the electronic device. Further, the method includes allocating, by the electronic device, the at least one resource operating performance configuration for the at least one application running in the electronic device based on the learning. The method includes accelerating, by the electronic device, execution of the application running in the electronic device.

In an embodiment, the method includes prioritizing, by the electronic device, the allocation of the at least one resources to at least one application from the plurality of applications based on at least one of at least one application performance and at least one system state. Further, the method includes allocating, by the electronic device, at least one resource operating performance configuration for at least one application running in the electronic device based on the priority.

In an embodiment, determining, by the electronic device, the nature of the task associated with the at least one application running in the electronic device and the parameter associated with the at least one application running in the electronic device includes determining, by the electronic device, at least one of at least one key module to be accelerated, a nature of the key-module and a time-duration for which acceleration is to be done at the at least one key module, and determining, by the electronic device, the nature of the task associated with the at least one application running in the electronic device and the parameter associated with at least one application running in the electronic device based on the determination.

In an embodiment, learning, by the electronic device, the at least one system configuration includes learning, by the electronic device, the at least one system configuration for different nature of at least one task associated with at least one application running in the electronic device and different parameters associated with at least one application running in the electronic device over a period time, and storing, by the electronic device, the learning in a memory.

In an embodiment, learning, by the electronic device, the at least one system configuration includes detecting, by the electronic device, a start of at least one event associated with the at least one application, sharing, by the electronic device, information associated with the at least one event to a processor, evaluating, by the electronic device, optimal setting against various stages of the at least one event and a system load associated with the at least one application, storing, by the electronic device, timestamp information, key performance indicator (KPI) information against various stages of the at least one event and tuneable decisions by the processor against the at least one event, detecting, by the electronic device, an end of at least one event associated with the at least one application, sending, by the electronic device, KPI versus timestamp information corresponding to at least one event to the memory, evaluating, by the electronic device, a performance of the KPI corresponding to at least one event to determine whether the KPI is met with a predefined value, performing one of computing a negative reward value upon determining the KPI is not met with the predefined value, and computing a positive reward value upon determining the KPI is met with the predefined value, sharing one of the positive reward value or the negative reward value to the processor, and storing learning of tuneable decision and one of the positive reward value or the negative reward value corresponding to a system load context information associated with the at least one application in the memory.

In an embodiment, allocating, by the electronic device, at least one resource operating performance configuration for the at least one application running in the electronic device includes detecting, by the electronic device, a start of at least one event associated with the at least one application, monitoring, by the electronic device, the at least one started event associated with the at least one application, selecting and applying at least one system configuration from a plurality of system configurations upon at least one started event associated with the at least one application, monitoring, by the electronic device, a KPI for the at least one system configuration from the plurality of system configurations, and allocating, by the electronic device, the at least one resource operating performance configuration for at least one application running in the electronic device based on the at least one system configuration and the KPI.

In accordance with another aspect of the disclosure, a method for handling an allocation of at least one resource operating performance configuration for at least one application running in an electronic device is provided. The method includes detecting, by the electronic device, a start of at least one event associated with the at least one application from a plurality of applications. Further, the method includes detecting, by the electronic device, at least one parameter as an input to set an optimal system configuration for accelerating execution of each event from the at least one event in the electronic device. Further, the method includes acquiring, by the electronic device, a plurality of previously saved system configurations based on at least one detected parameter. Further, the method includes identifying and applying, by the electronic device, the optimal configuration value from the plurality of previously saved system configurations to allocate of at least one optimal resource operating performance configuration for at least one application running in the electronic device. The method includes accelerating, by the electronic device, execution of the application running in the electronic device.

In an embodiment, the method includes detecting, by the electronic device, at least one subsequent event from at least one application, wherein the at least one subsequent event corresponds to a logical intermediate stage of an operation of the at least one application, and identifying and applying, by the electronic device, the optimal configuration value from the plurality of previously saved system configurations to allocate of at least one optimal resource operating performance configuration for at least one application running in the electronic device based on the at least one detected subsequent event.

In an embodiment, the method includes prioritizing, by the electronic device, the allocation of the at least one resources to the at least one application from the plurality of applications based on at least one of at least one application performance and at least one system state. Further, the method includes allocating, by the electronic device, at least one resource operating performance configuration for at least one application running in the electronic device based on the priority.

In accordance with another aspect of the disclosure, a method for handling at least one resource operating performance configuration in the electronic device is provided. The method includes determining, by the electronic device, at least one event to execute the at least one application from a plurality of applications running in the electronic device. Further, the method includes fetching, by the electronic device, a system configuration required to execute the at least one event associated with the at least one application based on the determination. Further, the method includes determining, by the electronic device, a nature of a task associated with at least one application running in the electronic device and a parameter associated with at least one application running in the electronic device. Further, the method includes learning, by the electronic device, at least one system configuration for the determined nature of the task associated with at least one application running in the electronic device and the determined parameter associated with at least one application running in the electronic device. Further, the method includes storing, by the electronic device, the at least one system configuration in a memory. The method includes accelerating, by the electronic device, execution of the application running in the electronic device.

In an embodiment, further, the method includes detecting, by the electronic device, a trigger for each event from the at least one event to accelerate execution of the at least one event, wherein the trigger is a start of an event from the at least one event. Further, the method includes applying, by the electronic device, the at least one system configuration on the at least one event to accelerate execution of the at least one event.

In accordance with another aspect of the disclosure, an electronic device for handling at least one resource operating performance configuration in the electronic device is provided. The electronic device includes a resource operating performance configuration allocation controller coupled with a processor and a memory. The resource operating performance configuration allocation controller is configured to determine at least one event which will result in execution the at least one application from a plurality of applications running in the electronic device. Further, the resource operating performance configuration allocation controller is configured to fetch a system configuration required to execute the at least one event associated with the at least one application based on the determination. Further, the resource operating performance configuration allocation controller is configured to modify the system configuration for each event from the at least one event to accelerate the execution of each event associated with the at least one application running in the electronic device. Further, the resource operating performance configuration allocation controller is configured to accelerate execution of the application running in the electronic device.

In accordance with another aspect of the disclosure, an electronic device for handling at least one resource operating performance configuration in the electronic device is provided. The electronic device includes a resource operating performance configuration allocation controller coupled with a processor and a memory. Further, the resource operating performance configuration allocation controller is configured to determine a nature of a task associated with the at least one application from a plurality of applications running in the electronic device and a parameter associated with at least one application running in the electronic device. Further, the resource operating performance configuration allocation controller is configured to learn at least one system configuration for the determined nature of the task associated with the at least one application running in the electronic device and the determined parameter associated with the at least one application running in the electronic device. Further, the resource operating performance configuration allocation controller is configured to allocate the at least one resource operating performance configuration for the at least one application running in the electronic device based on the learning. Further, the resource operating performance configuration allocation controller is configured to accelerate execution of the application running in the electronic device.

In accordance with another aspect of the disclosure, an electronic device for handling at least one resource operating performance configuration in the electronic device is provided. The electronic device includes a resource operating performance configuration allocation controller coupled with a processor and a memory. Further, the resource operating performance configuration allocation controller is configured to detect a start of at least one event associated with the at least one application from a plurality of applications. Further, the resource operating performance configuration allocation controller is configured to detect at least one parameter as an input to set an optimal system configuration for accelerating execution of each event from the at least one event in the electronic device. Further, the resource operating performance configuration allocation controller is configured to acquire a plurality of previously saved system configurations based on at least one detected parameter. Further, the resource operating performance configuration allocation controller is configured to identify and apply the optimal configuration value from the plurality of previously saved system configurations to allocate of at least one optimal resource operating performance configuration for at least one application running in the electronic device. Further, the resource operating performance configuration allocation controller is configured to accelerate execution of the application running in the electronic device.

In accordance with another aspect of disclosure, an electronic device for handling at least one resource operating performance configuration in the electronic device is provided. The electronic device includes a resource operating performance configuration allocation controller coupled with a processor and a memory. Further, the resource operating performance configuration allocation controller is configured to detect a start of at least one event associated with the at least one application from a plurality of applications. Further, the resource operating performance configuration allocation controller is configured to determine at least one event to execute the at least one application from a plurality of applications running in the electronic device. Further, the resource operating performance configuration allocation controller is configured to fetch a system configuration required to execute the at least one event associated with the at least one application based on the determination. Further, the resource operating performance configuration allocation controller is configured to determine a nature of a task associated with at least one application running in the electronic device and a parameter associated with at least one application running in the electronic device. Further, the resource operating performance configuration allocation controller is configured to learn at least one system configuration for the determined nature of the task associated with at least one application running in the electronic device and the determined parameter associated with at least one application running in the electronic device. Further, the resource operating performance configuration allocation controller is configured to accelerate execution of the application running in the electronic device based on the modified system configuration.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is an example illustration in which operation of a performance booster is explained, according to the related art;

FIG. 2 shows various hardware components of an electronic device for handling a resource operating performance configuration for accelerating execution of an application running in the electronic device, according to an embodiment of the disclosure;

FIG. 3 is a flow chart illustrating a method for handling the resource operating performance configuration for accelerating execution of the application running in the electronic device, according to an embodiment of the disclosure;

FIG. 4 is a flow chart illustrating a method for handling the resource operating performance configuration for accelerating execution of the application running in the electronic device, according to an embodiment of the disclosure;

FIG. 5 is a flow chart illustrating a method for handling the resource operating performance configuration for accelerating execution of the application running in the electronic device, according to an embodiment of the disclosure;

FIG. 6 is a flow chart illustrating a method for handling the resource operating performance configuration for accelerating execution of the application running in the electronic device, according to an embodiment of the disclosure;

FIGS. 7A and 7B are a flow chart illustrating a method for handling the resource operating performance configuration for accelerating execution of the application running in the electronic device, according to an embodiment of the disclosure;

FIG. 8 shows various operations of a learning performance engine integration flow explained in connection with FIG. 2, according to an embodiment of the disclosure; and

FIGS. 9 and 10 shows various operations of a learning module of the electronic device explained in connection with FIG. 2, according to various embodiments of the disclosure.

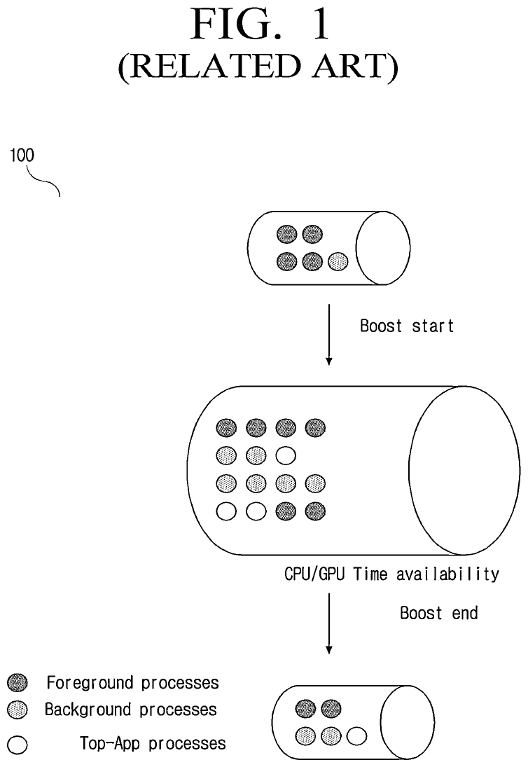

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The embodiments herein achieve methods for handling at least one resource operating performance configuration in an electronic device. The method includes determining, by the electronic device, at least one event that is generated by the at least one application from a plurality of applications running in the electronic device that requires acceleration of the at least one application from the plurality of applications running in the electronic device. Further, the method includes fetching, by the electronic device, a system configuration based on the determination. Further, the method includes modifying, by the electronic device, the system configuration for each event to accelerate the execution of each event associated with the at least one application running in the electronic device.

Unlike conventional methods and systems, the method can be used to provide a resource operating performance configuration allocation controller with the reinforcement learning to accelerate heavy use case for enterprise applications for improving performance in enterprise scenarios. The method can be used for allocating the appropriate hardware (H/W) resource to targeted application use cases based on machine learning (ML) model learning by effectively utilizing available H/W resource allocation to targeted application without degrading other process allocation by balancing power and thermal usage.

Based on the proposed method, policies get revamped against system state changes within the scenario. The proposed method can be used to apply different policy and observe how system behaves and learns. In real time, the proposed method can be used to apply the best policy for that use case. When a user increases the number of applications, which increases the background process, the system relearns the best policy based on the new system state. The proposed method can be used to prioritize the allocation of h/w resources to targeted application by allocating right cores to right process. If any associated background process, the method can be used to prioritize that as well ensuring the overall performance as better.

Based on the proposed method, B2B applications are provided with minimalistic API for allowing to utilize underlying hardware/software performance features to improve performance in their respective heavy use case scenario(s) without significant effort. The proposed method used for enabling B2B use case/scenario performance management, which learns on its own under varying system load condition what is the appropriate performance knobs to achieving best possible performance for an integrated scenario under different load condition. The method can manage automated learning, when scenario performance deteriorates from normal.

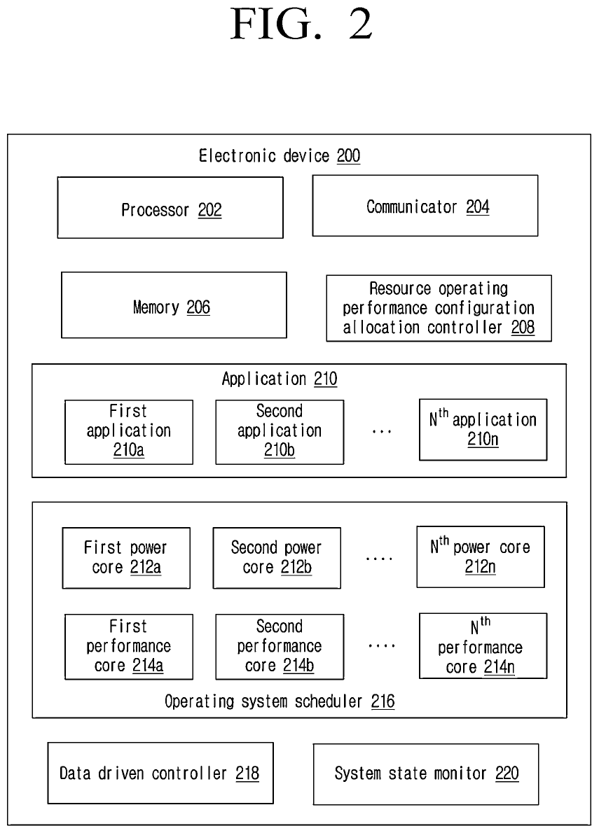

Referring now to the drawings, and more particularly to FIGS. 2 through 10, where similar reference characters denote corresponding features consistently throughout the figures, there are shown at least one embodiment.

FIG. 2 shows various hardware components of an electronic device (200) for handling a resource operating performance configuration for accelerating execution of an application running in the electronic device (200), according to an embodiment of the disclosure.

The electronic device (200) can be, for example, but not limited to a laptop, a desktop computer, a notebook, a vehicle to everything (V2X) device, a smartphone, a tablet, an internet of things (IoT) device, an immersive device, a virtual reality device, a foldable device or the like. The resource operating performance configuration can be, for example, but not limited to central processing unit (CPU) operating performance point (OPP), a graphics processing unit (GPU) OPP, a process aware scheduler configuration, an energy aware scheduler configuration, a process thread scheduling configuration and a priority scheduling configuration.

In an embodiment, the electronic device (200) includes a processor (202), a communicator (204), a memory (206), a resource operating performance configuration allocation controller (208), a plurality of applications (210) (e.g., a first application 210a, a second application 210b, . . . an Nth application 210n), a plurality of power cores (212a-212n), a plurality of performance cores (214a-214n), an operating system scheduler (216), a data driven controller (218), and a system state monitor (220). The processor (202) is coupled with the communicator (204), the memory (206), the resource operating performance configuration allocation controller (208), the plurality of applications (210), the plurality of power cores (212a-212n), the plurality of performance cores (214a-214n), an operating system scheduler (216), the data driven controller (218), and the system state monitor (220).

The resource operating performance configuration allocation controller (208) determines at least one event that is generated by at least one application from a plurality of applications (210) running in the electronic device (200) that requires acceleration of the at least one application from the plurality of applications (210) running in the electronic device (200). Based on the determination, the resource operating performance configuration allocation controller (208) fetches a system configuration and modifies the system configuration for each event to accelerate the execution of each event associated with the at least one application running in the electronic device (200). In an embodiment, the resource operating performance configuration allocation controller (208) determines the nature of a task associated with the at least one application running in the electronic device (200) and at least one parameter associated with at least one application running in the electronic device (200). The at least one parameter can be, for example, but not limited to a system load, temperature of the electronic device (200), power consumption, and internal component temperature. Further, the resource operating performance configuration allocation controller (208) learns at least one system configuration for the determined nature of the task associated with the at least one application running in the electronic device (200) and the determined parameter associated with the at least one application running in the electronic device (200). Based on learning, the resource operating performance configuration allocation controller (208) modifies the system configuration for each event to accelerate the execution of each event associated with the at least one application running in the electronic device (200).

Based on the modified system configuration, the resource operating performance configuration allocation controller (208) accelerates the execution of the application running in the electronic device (200)

Further, the resource operating performance configuration allocation controller (208) feeds the modified system configuration for each event to a data driven model or learning module using the data driven controller (218), where each event is accelerated by setting the modified system configuration, wherein the modified system configuration is fed to the data driven model for self-learning over a period of time.

Further, the resource operating performance configuration allocation controller (208) detects the trigger for each event to accelerate execution of the at least one event, where the trigger is a start of an event from the at least one event.

Further, the resource operating performance configuration allocation controller (208) detects the at least one parameter as an input to set an optimal system configuration for accelerated execution of each event in the electronic device (200).

In another embodiment, the resource operating performance configuration allocation controller (208) determines the nature of the task associated with the at least one application from the plurality of applications (210) running in the electronic device (200) and the parameter associated with at least one application running in the electronic device (200).

In an embodiment, the resource operating performance configuration allocation controller (208) determines at least one of at least one key module to be accelerated, a nature of the key-module and a time-duration for which acceleration is to be done at the at least one key module and determines the nature of the task associated with the at least one application running in the electronic device (200) and the parameter associated with at least one application running in the electronic device (200) based on the determination.

Further, the resource operating performance configuration allocation controller (208) learns the at least one system configuration for the determined nature of the task associated with the at least one application running in the electronic device (200) and the determined parameter associated with the at least one application running in the electronic device (200).

In an embodiment, the resource operating performance configuration allocation controller (208) learns the at least one system configuration for different nature of at least one task associated with at least one application running in the electronic device (200) and different parameters associated with at least one application running in the electronic device (200) over a period time and stores the learning in the memory (206).

In another embodiment, the resource operating performance configuration allocation controller (208) detects the start of at least one event associated with the at least one application and shares the information associated with the at least one event to the processor (202). Further, the resource operating performance configuration allocation controller (208) evaluates optimal setting against various stages of the at least one event and a system load associated with the at least one application. Further, the resource operating performance configuration allocation controller (208) stores timestamp information, key performance indicator (KPI) information against various stages of the at least one event and tuneable decisions by the processor (202) against the at least one event. Further, the resource operating performance configuration allocation controller (208) detects an end of at least one event associated with the at least one application. Further, the resource operating performance configuration allocation controller (208) sends the KPI versus timestamp information corresponding to at least one event to the memory (206). Further, the resource operating performance configuration allocation controller (208) evaluates the performance of the KPI corresponding to at least one event to determine whether the KPI is met with a predefined value. Further, the resource operating performance configuration allocation controller (208) computes a negative reward value upon determining the KPI is not met with the predefined value, and a positive reward value upon determining the KPI is met with the predefined value. Further, the resource operating performance configuration allocation controller (208) shares one of the positive reward value and the negative reward value to the processor (202). Further, the resource operating performance configuration allocation controller (208) stores the learning of tuneable decision and one of the positive reward value and the negative reward value corresponding to a system load context information associated with the at least one application in the memory (206).

In an example, the performance metric can be adapted to multiple use cases which may have different metrics to evaluate performance.

For example, for a given use-case like app launch the performance metric could be latency in drawing window over the screen. In another example, for a streaming/gaming use-case it could be the frames per second the device is able to render. Rewards for agents are defined according to the following equation:

Rᵢ=1−^{perfmetric}^{ᵢ}/MUB_{perfmetric}i^{th} step

where the Maximum Upper Bound (MUB) (interchangeably Average Upper Bound (AUB)) is updated every n iterations as follows:

MUBₜ=γMUBₜ₋₁+1−γrₘₐₓ

MUB_(t−1):updated new value of MUB_perf

MUB_t:previous value of MUB_perf

γ:memory parameter to control updation

r_max: running max

N is chosen as:

Each iteration over a use-case is independent

Using the Central Limit Theorem, provided a sample space X (n>=30) the distribution of the sample means will be approximately normally distributed. It holds true for both normal as well as skewed source population.

μₓ=μ and σ_{X}=σ/\sqrt{n}

Further, the resource operating performance configuration allocation controller (208) allocates the at least one resource operating performance configuration for the at least one application running in the electronic device (200) based on the learning. Further, the resource operating performance configuration allocation controller (208) accelerates the execution of the application running in the electronic device (200) based on the at least one allocated resource operating performance configuration.

Further, the resource operating performance configuration allocation controller (208) prioritizes the allocation of the at least one resource operating performance configuration to at least one application from the plurality of applications (210) based on at least one of at least one application performance and at least one system state. Further, the resource operating performance configuration allocation controller (208) allocates the at least one resource operating performance configuration for at least one application running in the electronic device (200) based on the priority.

In an embodiment, the resource operating performance configuration allocation controller (208) detects a start of at least one event associated with the at least one application. Further, the resource operating performance configuration allocation controller (208) monitors the at least one started event associated with the at least one application. Further, the resource operating performance configuration allocation controller (208) selects and applies at least one system configuration from a plurality of system configurations upon at least one started event associated with the at least one application. Further, the resource operating performance configuration allocation controller (208) monitors the KPI for the at least one system configuration from the plurality of system configurations. Further, the resource operating performance configuration allocation controller (208) allocates the at least one resource operating performance configuration for at least one application running in the electronic device (200) based on the at least one system configuration and the KPI.

In another embodiment, the resource operating performance configuration allocation controller (208) detects a start of at least one event associated with the at least one application from a plurality of applications (210) and detects at least one parameter as an input to set an optimal system configuration for accelerating execution of each event from the at least one event in the electronic device (200). Based on at least one detected parameter, the resource operating performance configuration allocation controller (208) acquires a plurality of previously saved system configurations. Further, the resource operating performance configuration allocation controller (208) identifies and applies the optimal configuration value from the plurality of previously saved system configurations to allocate of at least one optimal resource operating performance configuration for at least one application running in the electronic device (200). Based on the at least one optimal resource operating performance configuration, the resource operating performance configuration allocation controller (208) accelerates the execution of the application running in the electronic device (200)

Further, the resource operating performance configuration allocation controller (208) detects at least one subsequent event from at least one application. The at least one subsequent event corresponds to a logical intermediate stage of an operation of the at least one application. Further, the resource operating performance configuration allocation controller (208) identifies and applies the optimal configuration value from the plurality of previously saved system configurations to allocate of at least one optimal resource operating performance configuration for at least one application running in the electronic device based on the at least one detected subsequent event.

In another embodiment, the resource operating performance configuration allocation controller (208) determines the at least one event to execute the at least one application from a plurality of applications running in the electronic device (200). Based on the determination, the resource operating performance configuration allocation controller (208) fetches the system configuration required to execute the at least one event associated with the at least one application. Further, the resource operating performance configuration allocation controller (208) determines the nature of a task associated with at least one application running in the electronic device (200) and the parameter associated with at least one application running in the electronic device (200). Further, the resource operating performance configuration allocation controller (208) learns the at least one system configuration for the determined nature of the task associated with at least one application running in the electronic device (200) and the determined parameter associated with at least one application running in the electronic device (200). Based on the system configuration, the resource operating performance configuration allocation controller (208) accelerates execution of the application running in the electronic device (200).

Further, the system state monitor (220) supports an ecosystem for upper layer modules to obtain input data (i.e., system state) and perform the actions (knob control). The system agents can comprise multi-(mini)-agents, which are controlling chipset specific and agnostic aspects to deliver performance in an integrated scenario. The use case and model management modules can manage operations using underlying the multi-(mini)-agent(s) with respect to use integration, internal threading, training control, and so on. The system can integrate with other modules/system using license managed API access (B2B). The operating system scheduler (216) manages the plurality of power cores (212a-212n) and the plurality of performance cores (214a-214n) in the electronic device (200).

The system state monitor (220) is also called as a system context observer that learns and acts against the load context of underlying system. The mini-agents (not shown) control system-level resources. The mini-agents can be, for example, but not limited to CPU+HMP agent, a GPU agent, an affinity agent, a scheduler agent or the like. The system state monitor (220) directs the events from the electronic device (200) and use-case(s) to respective module (e.g., CPU, GPU or the like).

The resource operating performance configuration allocation controller (208) is physically implemented by analog or digital circuits such as logic gates, integrated circuits, microprocessors, microcontrollers, memory circuits, passive electronic components, active electronic components, optical components, hardwired circuits, or the like, and may optionally be driven by firmware.

Further, the processor (202) is configured to execute instructions stored in the memory (206) and to perform various processes. The communicator (204) is configured for communicating internally between internal hardware components and with external devices via one or more networks. The memory (206) also stores instructions to be executed by the processor (202). The memory (206) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (206) may, in some examples, be considered a non-transitory storage medium. The term “non-transitory” may indicate that the storage medium is not embodied in a carrier wave or a propagated signal. However, the term “non-transitory” should not be interpreted that the memory (206) is non-movable. In certain examples, a non-transitory storage medium may store data that can, over time, change (e.g., in Random Access Memory (RAM) or cache).

Further, at least one of the pluralities of modules/controller may be implemented through the AI model using a data driven controller (218). The data driven controller (218) can be a ML model based controller and AI model based controller. A function associated with the AI model may be performed through the non-volatile memory, the volatile memory, and the processor (202). The processor (202) may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU).

The one or a plurality of processors control the processing of the input data in accordance with a predefined operating rule or AI model stored in the non-volatile memory and the volatile memory. The predefined operating rule or artificial intelligence model is provided through training or learning.

Here, being provided through learning means that a predefined operating rule or AI model of a desired characteristic is made by applying a learning algorithm to a plurality of learning data. The learning may be performed in a device itself in which AI according to an embodiment is performed, and/o may be implemented through a separate server/system.

The AI model may comprise of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

Although FIG. 2 shows various hardware components of the electronic device (200) but it is to be understood that other embodiments are not limited thereon. In other embodiments, the electronic device (200) may include a larger or smaller number of components. Further, the labels or names of the components are used only for illustrative purpose and does not limit the scope of the disclosure. One or more components can be combined together to perform same or substantially similar function in the electronic device (200).

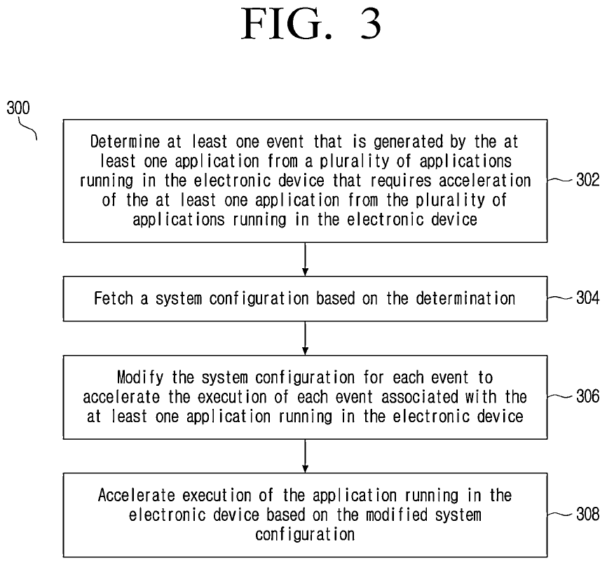

FIGS. 3, 4, 5, 6, 7A and 7B are flow charts (300-700) illustrating a method for handling the resource operating performance configuration for accelerating execution of the application (210) running in the electronic device (200), according to various embodiments of the disclosure.

Referring to FIG. 3, in flow chart 300 the operations (302-308) are handled by the resource operating performance configuration allocation controller (208). At operation 302, the method includes determining the at least one event that is generated by at least one application from the plurality of applications (210) running in the electronic device (200) that requires acceleration of the at least one application from the plurality of applications (210) running in the electronic device (200). At operation 304, the method includes fetching the system configuration based on the determination. At operation 306, the method includes modifying the system configuration for each event to accelerate the execution of each event associated with the at least one application running in the electronic device (200). At operation 308, the method includes accelerating execution of the application running in the electronic device (200) based on the modified system configuration.

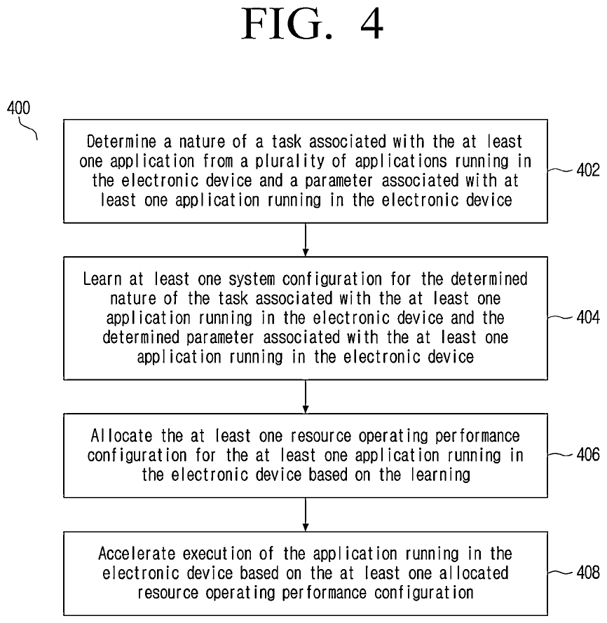

FIG. 4 is a flow chart illustrating a method for handling the resource operating performance configuration for accelerating execution of the application running in the electronic device, according to an embodiment of the disclosure.

Referring to FIG. 4, in flow chart 400 the operations (402-408) are handled by the resource operating performance configuration allocation controller (208). At operation 402, the method includes determining the nature of the task associated with the at least one application from the plurality of applications (210) running in the electronic device (200) and the parameter associated with at least one application running in the electronic device (200). At operation 404, the method includes learning the at least one system configuration for the determined nature of the task associated with the at least one application running in the electronic device (200) and the determined parameter associated with the at least one application running in the electronic device (200).

At operation 406, the method includes allocating the at least one resource operating performance configuration for the at least one application running in the electronic device (200) based on the learning. At operation 408, the method includes accelerating execution of the application running in the electronic device (200) based on the at least one allocated resource operating performance configuration.

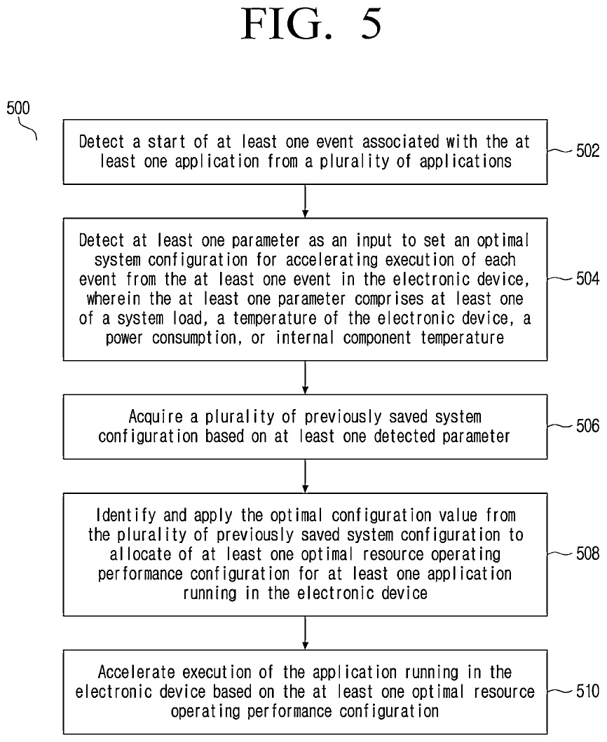

FIG. 5 is a flow chart illustrating a method for handling the resource operating performance configuration for accelerating execution of the application running in the electronic device, according to an embodiment of the disclosure.

Referring to FIG. 5, in flow chart 500 the operations (502-510) are handled by the resource operating performance configuration allocation controller (208). At operation 502, the method includes detecting the start of at least one event associated with the at least one application from the plurality of applications (210). At operation 504, the method includes detecting the at least one parameter as an input to set the optimal system configuration for accelerating execution of each event from the at least one event in the electronic device (200). The at least one parameter can be, for example, but not limited to at least one of a system load, a temperature of the electronic device (200), a power consumption, or internal component temperature.

At operation 506, the method includes acquiring the plurality of previously saved system configurations based on at least one detected parameter. At operation 508, the method includes identifying and applying the optimal configuration value from the plurality of previously saved system configurations to allocate of at least one optimal resource operating performance configuration for at least one application running in the electronic device (200). At operation 510, the method includes accelerating the execution of the application running in the electronic device (200) based on the at least one optimal resource operating performance configuration.

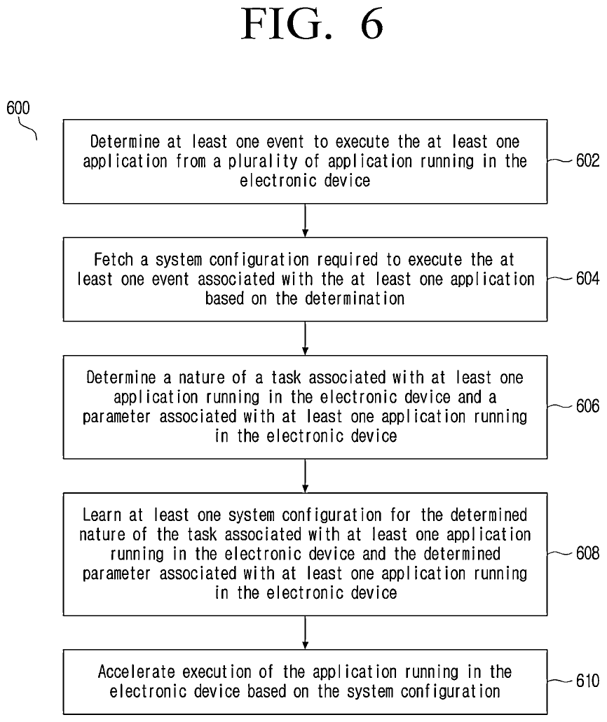

FIG. 6 is a flow chart illustrating a method for handling the resource operating performance configuration for accelerating execution of the application running in the electronic device, according to an embodiment of the disclosure.

Referring to FIG. 6, in flow chart 600 the operations (602-610) are handled by the resource operating performance configuration allocation controller (208). At operation 602, the method includes determining the at least one event to execute the at least one application from the plurality of applications (210) running in the electronic device (200). At operation 604, the method includes fetching the system configuration required to execute the at least one event associated with the at least one application based on the determination. At operation 606, the method includes determining the nature of a task associated with at least one application running in the electronic device (200) and the parameter associated with at least one application running in the electronic device (200).

At operation 608, the method includes learning the at least one system configuration for the determined nature of the task associated with at least one application running in the electronic device (200) and the determined parameter associated with at least one application running in the electronic device (200). At operation 610, the method includes accelerating execution of the application running in the electronic device (200) based on the system configuration.

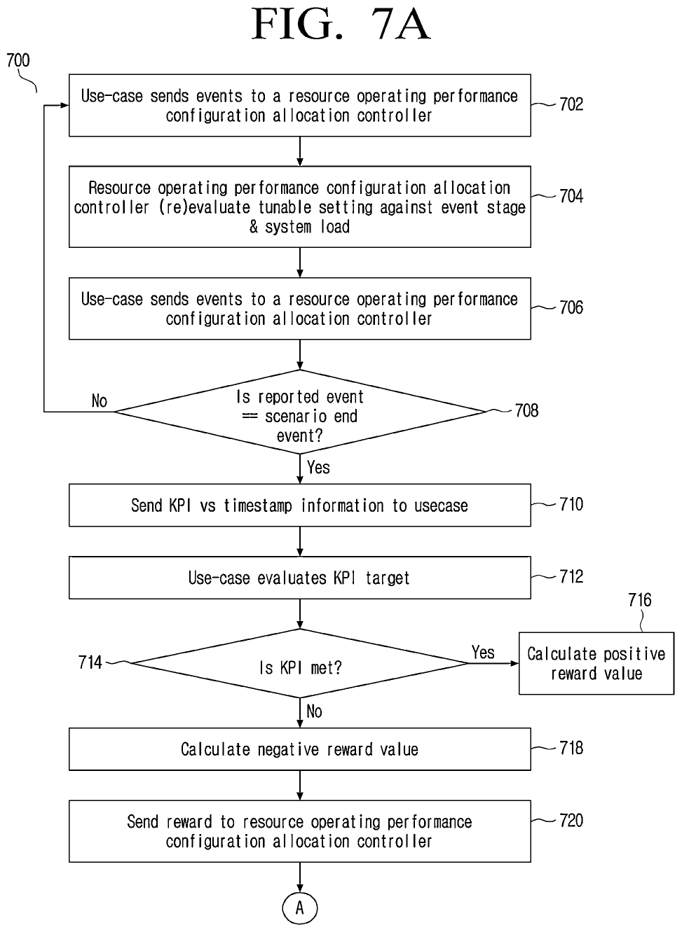

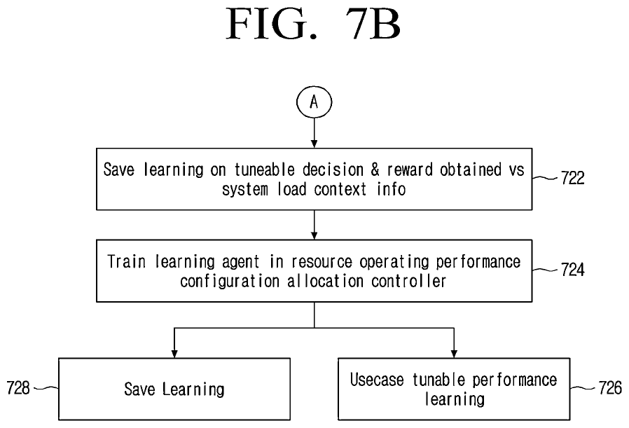

FIGS. 7A and 7B are a flow chart illustrating a method for handling the resource operating performance configuration for accelerating execution of the application running in the electronic device, according to an embodiment of the disclosure.

Referring to FIGS. 7A and 7B, in flow chart 700 the operations (702-728) are handled by the resource operating performance configuration allocation controller (208). At operation 702, the use-case sends the events to the resource operating performance configuration allocation controller (208). At operation 704, the resource operating performance configuration allocation controller (208) (re)evaluates the tunable setting against event stage and the system load. At operation 706, the resource operating performance configuration allocation controller (208) stores the timestamp, scenario specific KPI achieved and tunable decisions by resource operating performance configuration allocation controller (208) against reported events.

At operation 708, the method includes determining whether the reported event is equal to the scenario end event. If the reported event is not equal to the scenario end event then, at operation 702, the use-case sends the events to the resource operating performance configuration allocation controller (208). If the reported event is equal to the scenario end event then, at operation 710, the method includes sending the KPI versus the timestamp information to use-case.

At operation 712, the use-case evaluates the KPI target. At operation 714, the method includes determining whether the KPI is met. If the KPI is met then, at operation 716, the method includes calculating the positive reward value. If the KPI is not met then, at operation 718, the method includes calculating the negative reward value. At operation 720, the method includes sending the reward to the resource operating performance configuration allocation controller (208).

At operation 722, the method includes saving the learning on tunable decision and reward obtained versus the system load context information. At operation 724, the method includes training the learning agent in resource operating performance configuration allocation controller (208). At operation 726, the method includes learning the use-case tunable performance. At operation 728, the method saves the learning in the memory (206).

The proposed method can be used to balance the performance at power and thermal balancing in the enterprise application.

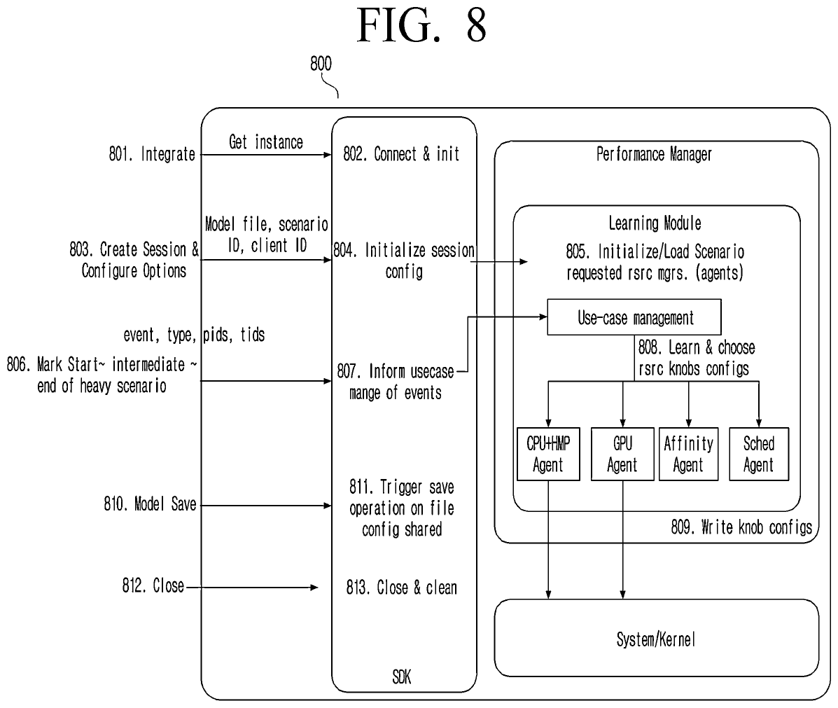

FIG. 8 shows various operations (800) of a learning performance engine integration flow explained in connection with FIG. 2, according to an embodiment of the disclosure.

Referring to FIG. 8, at use-case side: At operations 801 and 803, the application corresponding to the use case connects to performance engine, configures and establishes a session. At operation 806, during the heavy scenario (which needs acceleration), the application sends events to the processor engine. At operation 810, the issues request to save the model and at operation 812, the application closes and clean-ups the session,

At the performance manager side, on receiving a session creation request from the use-case, engine initializes the mini-learning-agents as requested at operations 802, 804, and 805. If an existing model (learning) file is provided from usecase, the performance manager loads and initializes with the same learning file. On receiving start/intermediate events, the performance manager identifies the performance knob configuration from the previous learnings at operations 808 and 809. On receiving end event, the performance manager evaluates the outcome of scenario (completion time). If completion time has become worse compared to previous experience, the provide negative reward for the choices (decisions) made by agents in the iteration. If completion time has become improved or remained same to previous experience, the provide positive reward for the choices (decisions) made by agents in the iteration. The learning model saves learning.

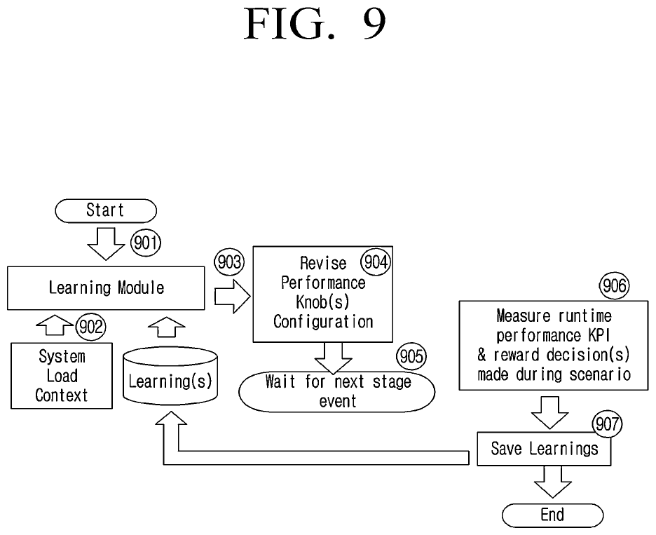

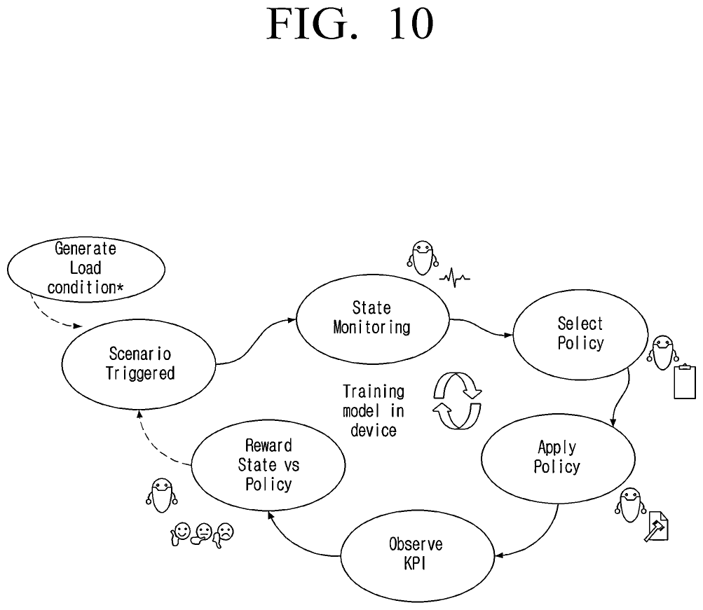

FIGS. 9 and 10 shows various operations of the learning module of the electronic device (200) explained in connection with FIG. 2, according to various embodiments of the disclosure.

Referring to FIG. 9, at operation 901, the enterprise application starts a heavy scenario which requires performance acceleration for faster completion. The enterprise application informs start of its heavy use-case scenario in the form of an event via an API to a learning module. The learning module is implemented using any of the following Model Free Reinforcement Learning methods such as Q-Learning technique, State-action-reward-state-action (SARSA) technique, Deep Q-Learning technique, Actor Critic class of technique, a policy Gradient technique. The learning module uses an extended Berkeley Packet Filter (eBPF) to capture CPU Utilisation, CPU load and related system load statistics. As an alternative, this can also be achieved using a loadable Operating system kernel module. The eBPF is a high-performance virtual machine which runs inside operating system kernel (e.g., linux kernel or the like) and is extensively used for system monitoring. The eBPF allows running of sandboxed linux programs without changing kernel source code.

At operation 902, on receiving this event, the learning module loads previously saved learnings about particular scenarios runtime performance. It also obtains the underlying systems load context as input. At operation 903, from the loaded learnings, the learning module identifies an optimal configuration value that can be applied to available performance configuration knob(s) available at its disposal, which yielded good performance results for scenario to complete

At operation 904, the identified configuration is applied by the learning module immediately on the performance knob(s). At operation 905, the learning module waits for additional events from the enterprise application. These additional events correspond to logical intermediate stages of a use-case or completion of the scenario. On each of these events, the learning module repeats the operations through 902 to 904 repeatedly in real-time manner.

At operation 906, on receiving an end event of a scenario the learning module measure the time duration from start to end event of heavy scenario which indicates completion timing of the same. At operation 907, the calculated completion timing is used as a reward on the entire series of decision made in operations 903 and 904. This reward is used by learning module to update learnings for the use-case. This learning is saved in persistent storage for future use-case invocation.

Further, the enterprise application developer will be provided the Application Programming Interface (API) to share event information corresponding to start, intermediate stages and completion of a scenario. Furthermore, the API will provide additional configuration parameters for learning module to operate. These can include type of resource acceleration (e.g., CPU, GPU, Process etc.) requested by the use-case, nature of use-case (e.g., foreground, background, mix of both), key modules (important processes and threads) involved in it etc. Further, the heavy use-case may contain more than one application processes involved in it which requires to be accelerated to faster completion of the overall use-case.

The learning module will contain more than one mini-learning modules which manages a logical grouping of performance knob(s). This allows faster learning rates for learning modules in the use-case. An example of this logical grouping can be Operating Performance point (clocks and voltages) of computing units such as CPU or GPU, process or energy aware scheduler configurations governing priority access, managing priority & scheduling configurations of the key processes etc.

Further, the learning saved by learning module is maintained against corresponding use-case. It contains all relevant information to reproduce performance results in various iterations of same use-case. The information can include numerical values representing benefits obtained of previous decisions of performance knob's parameters chosen to be applied, hyper parameter of learning module.

The saved learnings file stored in secondary storage against the use-case will contain all the learning of mini-learning agents, which will be used to load and initialize the agents during runtime. The learning module or mini-learning module may be implemented using different intelligent methods including Reinforcement Learning, Iterative Machine Learning methods the scope of which resides beyond this embodiment. The choice of learning method is decided against the nature of system environment it is developed & deployed against. The API may perform license and security checks to confirm whether an authorized enterprise application is only invoking the learning module functions.

Referring to FIG. 10, in an example, the model for each chipset gets trained within the electronic device (200) prior to commercialization. The training mode can be enabled and disabled at runtime without binary change. In the training enable mode, the model learns appropriate policy to meet optimal or improved KPI for each iteration of scenario under different loaded condition. In the training disable mode, the policies are selected from previous learning. If a new state is encountered for which training is not done, the electronic device reverts to base policy or a fall-back policy. If learned policy is available, the electronic device selects the high rewarded policy and if not available, the electronic device selects the best possible policy by applying a softmax technique.

The various actions, acts, blocks, steps, or the like in the flow charts (300-700) may be performed in the order presented, in a different order or simultaneously. Further, in some embodiments, some of the actions, acts, blocks, steps, or the like may be omitted, added, modified, skipped, or the like without departing from the scope of the disclosure.

The embodiments disclosed herein can be implemented through at least one software program running on at least one hardware device and performing network management functions to control the elements. The elements can be at least one of a hardware device, or a combination of hardware device and software module.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for handling at least one resource operating performance configuration in an electronic device, the method comprising:
determining, by the electronic device, at least one event that is generated by at least one application among a plurality of applications running in the electronic device that requires acceleration of the at least one application from the plurality of applications running in the electronic device;
fetching, by the electronic device, a system configuration based on the determination;
modifying, by the electronic device, the system configuration for each event to accelerate execution of each event associated with the at least one application running in the electronic device; and
accelerating, by the electronic device, execution of the application running in the electronic device based on the modified system configuration.

2. The method of claim 1, further comprising:
feeding, by the electronic device, the modified system configuration for each event to a data driven model,
wherein each event is accelerated by setting the modified system configuration, and
wherein the modified system configuration is fed to the data driven model for self-learning over a period of time.

3. The method of claim 1, wherein the modifying, by the electronic device, of the system configuration for each event to accelerate the execution of each event associated with the at least one application running in the electronic device comprises:
determining, by the electronic device, a nature of a task associated with the at least one application running in the electronic device and at least one parameter associated with at least one application running in the electronic device, wherein the at least one parameter comprises at least one of a system load, temperature of the electronic device, power consumption, or an internal component temperature;
learning, by the electronic device, at least one system configuration for the determined nature of the task associated with the at least one application running in the electronic device and the determined parameter associated with the at least one application running in the electronic device; and
modifying, by the electronic device, the system configuration for each event to accelerate the execution of each event associated with the at least one application running in the electronic device based on the learning.

4. The method of claim 1, further comprising:
detecting, by the electronic device, a trigger for each event to accelerate execution of the at least one event,
wherein the trigger is a start of an event from the at least one event.

5. The method of claim 1, further comprising:
detecting, by the electronic device, at least one parameter as an input to set an optimal system configuration for accelerated execution of each event in the electronic device,
wherein the at least one parameter comprises at least one of a system load, temperature of the electronic device, power consumption, or an internal component temperature.

6. The method of claim 1, wherein the resource operating performance configuration comprises at least one of:
a central processing unit (CPU) Operating Performance Point (OPP);
a graphics processing unit (GPU) OPP;
a process aware scheduler configuration;
an energy aware scheduler configuration;
a process thread scheduling configuration; or
a priority scheduling configuration.

7. A method for handling at least one resource operating performance configuration in an electronic device, the method comprising:
determining, by the electronic device, a nature of a task associated with at least one application among a plurality of applications running in the electronic device and a parameter associated with the at least one application running in the electronic device;
learning, by the electronic device, at least one system configuration for the determined nature of the task associated with the at least one application running in the electronic device and the determined parameter associated with the at least one application running in the electronic device;
allocating, by the electronic device, the at least one resource operating performance configuration for the at least one application running in the electronic device based on the learning; and
accelerating, by the electronic device, execution of the application running in the electronic device based on the at least one allocated resource operating performance configuration.

8. The method of claim 7, further comprising:
prioritizing, by the electronic device, the allocation of the at least one resource operating performance configuration to at least one application from the plurality of applications based on at least one of at least one application performance or at least one system state; and
allocating, by the electronic device, at least one resource operating performance configuration for at least one application running in the electronic device based on the priority.

9. The method of claim 7, wherein the determining, by the electronic device, of the nature of the task associated with the at least one application running in the electronic device and the parameter associated with the at least one application running in the electronic device comprises:
determining, by the electronic device, at least one of at least one key module to be accelerated, a nature of the at least one key module, or a time-duration for which acceleration is to be done at the at least one key module; and
determining, by the electronic device, the nature of the task associated with the at least one application running in the electronic device and the parameter associated with at least one application running in the electronic device based on the determination.

10. The method of claim 7, wherein the learning, by the electronic device, of the at least one system configuration comprises:
learning, by the electronic device, the at least one system configuration for a different nature of at least one task associated with at least one application running in the electronic device and different parameters associated with the at least one application running in the electronic device over a period time; and
storing, by the electronic device, the learning in a memory.

11. The method of claim 7, wherein the learning, by the electronic device, of the at least one system configuration comprises:
detecting, by the electronic device, a start of at least one event associated with the at least one application;
sharing, by the electronic device, information associated with the at least one event to a processor;
evaluating, by the electronic device, optimal setting against various stages of the at least one event and a system load associated with the at least one application;
storing, by the electronic device, timestamp information, key performance indicator (KPI) information against various stages of the at least one event and tuneable decisions by the processor against the at least one event;
detecting, by the electronic device, an end of at least one event associated with the at least one application;
sending, by the electronic device, KPI versus timestamp information corresponding to at least one event to a memory;
evaluating, by the electronic device, a performance of the KPI corresponding to at least one event to determine whether the KPI is met with a predefined value;
performing one of computing a negative reward value upon determining the KPI is not met with the predefined value or computing a positive reward value upon determining the KPI is met with the predefined value;
sharing one of the positive reward value or the negative reward value to the processor; and
storing learning of tuneable decision and one of the positive reward value or the negative reward value corresponding to a system load context information associated with the at least one application in the memory.

12. The method of claim 11, wherein the positive reward value and the negative reward value correspond to a system load context information associated with the at least one application in the memory.

13. The method of claim 11,
wherein the reward value is negative if completion time has become worse compared to previous experience, and
wherein the reward value is positive if completion time has become improved or remained same compared to previous experience.

14. The method of claim 7, wherein the allocating, by the electronic device, of the at least one resource operating performance configuration for the at least one application running in the electronic device comprises:
detecting, by the electronic device, a start of at least one event associated with the at least one application;
monitoring, by the electronic device, the at least one started event associated with the at least one application;
selecting and applying at least one system configuration from a plurality of system configurations upon at least one started event associated with the at least one application;
monitoring, by the electronic device, a key performance indicator (KPI) for the at least one system configuration from the plurality of system configurations; and
allocating, by the electronic device, the at least one resource operating performance configuration for the at least one application running in the electronic device based on the at least one system configuration and the KPI.

15. The method of claim 7,
wherein the resource operating performance configuration comprises at least one of:
a central processing unit (CPU) Operating Performance Point (OPP),
a graphics processing unit (GPU) OPP,
a process aware scheduler configuration,
an energy aware scheduler configuration,
priority scheduling configuration, or
a process thread scheduling configuration, and
wherein the at least one parameter comprises at least one of a system load, temperature of the electronic device, power consumption, or an internal component temperature.

16. A method for handling at least one resource operating performance configuration in an electronic device, comprising:
detecting, by the electronic device, a start of at least one event associated with at least one application among a plurality of applications;
detecting, by the electronic device, at least one parameter as an input to set an optimal system configuration for accelerating execution of each event from the at least one event in the electronic device, wherein the at least one parameter comprises at least one of a system load, a temperature of the electronic device, a power consumption, or an internal component temperature;
acquiring, by the electronic device, a plurality of previously saved system configurations based on at least one detected parameter;
identifying and applying, by the electronic device, an optimal configuration value from the plurality of previously saved system configurations to allocate of at least one optimal resource operating performance configuration for at least one application running in the electronic device; and
accelerating, by the electronic device, execution of the application running in the electronic device based on the at least one optimal resource operating performance configuration.

17. The method of claim 16, further comprising:
detecting, by the electronic device, at least one subsequent event from at least one application, wherein the at least one subsequent event corresponds to a logical intermediate stage of an operation of the at least one application; and
identifying and applying, by the electronic device, the optimal configuration value from the plurality of previously saved system configurations to allocate of at least one optimal resource operating performance configuration for at least one application running in the electronic device based on the at least one detected subsequent event.

18. The method of claim 16, further comprising:
prioritizing, by the electronic device, the allocation of the at least one resource to the at least one application among the plurality of applications based on at least one of at least one application performance or at least one system state.

19. The method of claim 18, further comprising:
allocating, by the electronic device, at least one resource operating performance configuration for at least one application running in the electronic device based on the prioritizing.
